(19) United States
(12) Patent Application Publication
(10) Pub. No.: US 2016/0196342 A1
(43) Pub. Date: Jul. 7, 2016

(54) Plagiarism Document Detection System Based on Synonym Dictionary and Automatic Reference Citation Mark Attaching System

(71) Applicants: INHA-Industry Partnership, Incheon (KR); DAOLSOFT INC., Seoul (KR)

(72) Inventors: Yoo Sung Kim, Incheon (KR); Kwang Ho Song, Seoul (KR); Ji Hong Min, Gyeonggi-do (KR)

(73) Assignees: INHA-Industry Partnership, Incheon (KR); DAOLSOFT INC., Seoul (KR)

(21) Appl. No.: 14/618,083

(22) Filed: Feb. 10, 2015

(30) Foreign Application Priority Data
Jan. 6, 2015 (KR) 10-2015-0001159
Jan. 30, 2015 (KR) 10-2015-0015487

(51) Int. Cl. G06F 17/30; G06F 17/27

(52) U.S. Cl. CPC G06F 17/30728; G06F 17/30684; G06F 17/2795; G06F 17/30312

(57) ABSTRACT

A plagiarism document detecting system and an automatic reference citation mark attaching system are provided which are capable of providing an on-line service and are based on a synonym dictionary. The automatic reference citation mark attaching system includes a memory on which at least one program is loaded and at least one processor. Based on a control of the program, the at least one processor performs operations of checking similarities between original sentences, included in an original document, and test sentences generated by dividing a to-be-inspected target document by the sentence; and providing bibliographic information of the original document as reference information on the test sentences when the similarities between the test sentences and the original sentences exceed a predetermined criteria.

### CROSS-REFERENCE TO RELATED APPLICATIONS

A claim for priority under 35 U.S.C. §119 is made to Korean Patent Application No. 10-2015-0001159 filed Jan. 6, 2015, and Korean Patent Application No. 10-2015-0015487 filed Jan. 30, 2015, in the Korean Intellectual Property Office, the entire contents of which are hereby incorporated by reference.

### BACKGROUND

Embodiments of the inventive concepts described herein relate to a system capable of detecting a plagiarism document on-line and attaching a citation mark on a reference.

A reference is an associated document attached to a treatise or a report and is very significant. In general, the treatise can be evaluated through a table of contents, an introduction, and a reference. The reason is that whether to refer a literature suitable for contents described in a subject and the introduction is important upon making the treatise.

Various indexes including the SCI (Science Citation Index) developed by the ISI corporation of the U.S. are being researched as a citation index on a reference.

However, such indexes are obtained by manually analyzing references, and the role of the indexes is restricted because citation information between literatures is assigned.

Meanwhile, plagiarism on technical documents has become a problem at home and abroad, and the problem of plagiarism has become an issue. To solve such a problem, there are studied techniques for determining whether a technical document is plagiarized, on-line through the Internet or through an independent work.

A service which is capable of solving suspicion of plagiarism on a technical document being written does not exist up to now.

### SUMMARY

Embodiments of the inventive concepts provide a system capable of allowing a technical document being written to be free from suspicion of plagiarism.

Embodiments of the inventive concepts provide a system capable of automatically attaching a citation mark on a reference to a technical document.

Embodiments of the inventive concepts provide a system capable of suggesting a revision of a relevant sentence according to a position in a technical document of a plagiarism-suspected sentence.

Embodiments of the inventive concepts provide a system that extracts a keyword set from documents through preprocessing, such as morpheme analysis and elimination of stop words, and stores the keyword set together with a representative synonym at database using a synonym dictionary, thereby detecting plagiarism types such as liberal translation and structure change.

One aspect of embodiments of the inventive concept is directed to provide an automatic reference citation mark attaching system which includes a memory on which at least one program is loaded and at least one processor. Based on a control of the program, the at least one processor performs operations of checking similarities between original sentences, included in an original document, and test sentences generated by dividing a to-be-inspected target document by the sentence; and providing bibliographic information of the original document as reference information on the test sentences when the similarities between the test sentences and the original sentences exceed a predetermined criteria.

Another aspect of embodiments of the inventive concept is directed to provide a plagiarism detecting system which includes a memory on which at least one program is loaded and at least one processor. Based on a control of the program, the at least one processor performs operations of performing a preprocessing operation where each of original documents and a to-be-inspected target document is divided by the word and the division result is stored at database together with a representative synonym found from a synonym dictionary; selecting a first document, similar to the to-be-inspected target document, from among the original documents, according to a Jaccard coefficient based similarity; and selecting a second document, similar to the to-be-inspected target document, from among the first documents according to a cosine distance based similarity.

Still another aspect of embodiments of the inventive concept is directed to provide a plagiarism detecting system which includes a memory on which at least one program is loaded and at least one processor. Based on a control of the program, the at least one processor performs operations of dividing original documents by the word to store the division result at database together with a representative synonym found from a synonym dictionary; dividing a to-be-inspected target document, uploaded from a user through an internet, by the word to store the division result at the database together with a representative synonym found from the synonym dictionary; checking a plagiarism of the to-be-inspected target document by comparing the to-be-inspected target document and the original documents; and providing the checking result to one of the user and a manager registering the original documents.

According to an exemplary embodiment of the inventive concept, since a citation mark on a reference is automatically attached to a technical document, it is possible to prevent a social plagiarism issue in advance, thereby making it possible to solve suspicion of plagiarism on the technical document.

According to an exemplary embodiment of the inventive concept, since there are provided various services for preemptively solving suspicion of plagiarism on a draft of a technical document being written through similar sentence detecting, it is possible to provide a technical document writing environment that is free from suspicion of plagiarism.

According to exemplary embodiments of the inventive concept, keywords of an original document and a to-be-inspected target document may be stored at database together with a representative synonym found from the synonym dictionary and may be used at a plagiarism identifying step. Thus, it is possible to find the following various plagiarism types: copying a sentence of an original document without modification, liberal translation where a keyword is replaced with any other similar keyword, and structure change where the word order of a sentence is changed.

According to an exemplary embodiment of the inventive concept, a Jaccard coefficient based filtering step is added before a cosine distance based filtering step, thereby reducing the number of documents needed to calculate similarity for identifying whether or not of plagiarism. That is, performance may be improved in terms of an execution time as compared with a conventional system using only the cosine distance based filtering step.

According to an exemplary embodiment of the inventive concept, since an on-line plagiarism detection service is provided to a plurality of users, it is possible to support the following various functions usable through an on-line service: a general plagiarism document detecting function, a history function for identifying a plagiarism detection history, a details query function for identifying a plagiarism portion in a document, and a citation information supplying function for providing bibliographic information of a found document.

### BRIEF DESCRIPTION OF THE FIGURES

The above and other objects and features will become apparent from the following description with reference to the following figures, wherein like reference numerals refer to like parts throughout the various figures unless otherwise specified, and wherein

FIG. 1 is a whole configuration diagram of a plagiarism document detecting system based on a synonym dictionary and providing an on-line service, according to an exemplary embodiment of the inventive concept;

FIG. 2 is a diagram for describing a preprocessing step for finding a plagiarism document;

FIG. 3 is a diagram illustrating a result of evaluating performance of a plagiarism detecting system to which only a cosine similarity based filtering step is applied;

FIG. 4 is a diagram for describing a method for calculating similarity of a vector space model;

FIG. 5 is a flowchart schematically illustrating a plagiarism detecting method including a Jaccard coefficient based filtering step, according to an exemplary embodiment of the inventive concept;

FIG. 6 is a diagram schematically illustrating a filtering step using a Jaccard coefficient, according to an exemplary embodiment of the inventive concept.

FIGS. 7 and 8 are diagrams illustrating a preprocessing result on an exemplary sentence of a to-be-inspected target document and an exemplary sentence;

FIG. 9 is a diagram illustrating a database schema for supporting an on-line plagiarism detecting service, according to an exemplary embodiment of the inventive concept;

FIG. 10 is a configuration and flowchart of an on-line plagiarism detecting service according to an exemplary embodiment of the inventive concept;

FIG. 11 is a structure diagram of an automatic reference citation mark attaching system according to an exemplary embodiment of the inventive concept;

FIG. 12 is a flowchart schematically illustrating an automatic reference citation mark attaching method according to an exemplary embodiment of the inventive concept;

FIG. 13 is a diagram schematically illustrating a system for an on-line plagiarism detecting service and automatic reference citation mark attachment and a user terminal; and

FIG. 14 is a block diagram for describing an internal configuration of a plagiarism detecting system, according to an exemplary embodiment of the inventive concept.

### DETAILED DESCRIPTION

Embodiments will be described in detail with reference to the accompanying drawings. The inventive concept, however, may be embodied in various different forms, and should not be construed as being limited only to the illustrated embodiments. Rather, these embodiments are provided as examples so that this disclosure will be thorough and complete, and will fully convey the concept of the inventive concept to those skilled in the art. Accordingly, known processes, elements, and techniques are not described with respect to some of the embodiments of the inventive concept. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

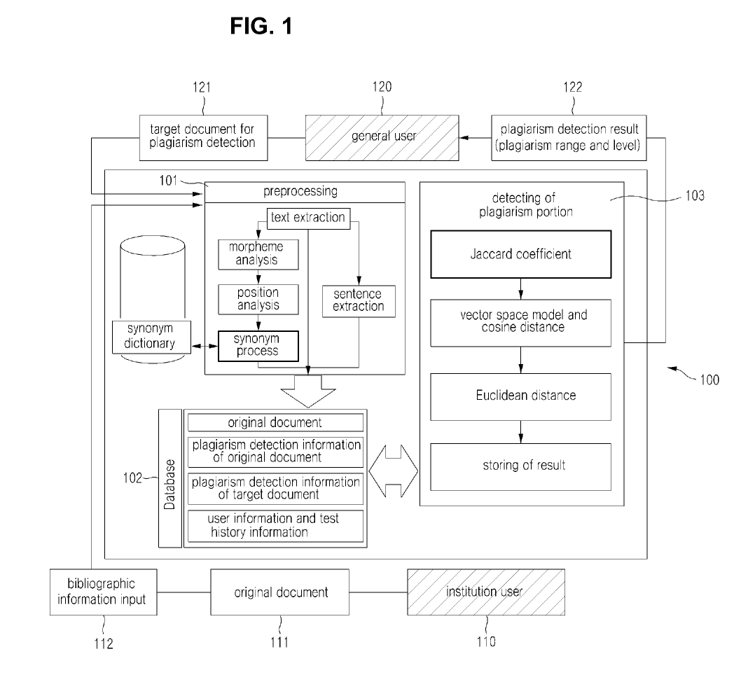

FIG. 1 is a whole configuration diagram of a plagiarism document detecting system based on a synonym dictionary and providing an on-line service, according to an exemplary embodiment of the inventive concept.

In this specification, there is provided a way for designing database of a plagiarism detecting system based on a synonym dictionary to provide an on-line plagiarism search service and bettering a filtering step to improve the performance of identifying the plagiarism.

A plagiarism detecting system 100 according to an exemplary embodiment of the inventive concept may divide an original document 111 and a to-be-inspected target document 121 by the word at preprocessing 101, may search for a keyword set and a representative synonym on the keyword set from a synonym dictionary, may store the keyword set, keyword position information in a document, and the representative synonym together at the database 102, and may detect the following plagiarism based on the database 102: liberal translation and change in a sentence structure.

In other words, the plagiarism detecting system 100 extracts the keyword set from the original document 111 and the to-be-inspected target document 121 through the preprocessing 101, such as morpheme analysis and elimination of stop words, and stores the keyword set together with a representative synonym at the database 102 using the synonym dictionary, thereby detecting plagiarism types, such as copy, abbreviation, liberal translation, and structure change on the original document 111.

At this time, in case of detecting plagiarism using the morpheme analysis, a time taken to detect plagiarism becomes longer as compared with a conventional plagiarism detecting system using pattern matching. However, the plagiarism detecting system 100 according to an exemplary embodiment of the inventive concept may reduce the number of documents for similarity calculation, which is performed to check whether or not of plagiarism, by adding a Jaccard coefficient based filtering step before a cosine distance based filtering step at a plagiarism portion detecting step 103, thereby improving performance in terms of an execution time.

As an embodiment of a plagiarism document detecting method, index keys are generated by sequentially grouping word phrases of a sentence included in the original document corresponding to a target to be inspected, and search keys on sentences in the to-be-inspected target document are generated in the same manner as described above. Afterwards, the plagiarism inspection is performed in an N-gram manner where two keys are compared by the syllable or in a manner where relevant keys are compared after converted into hash codes. This method is excellent to detect plagiarism of a copy type but is disadvantageous to search for another type of plagiarism.

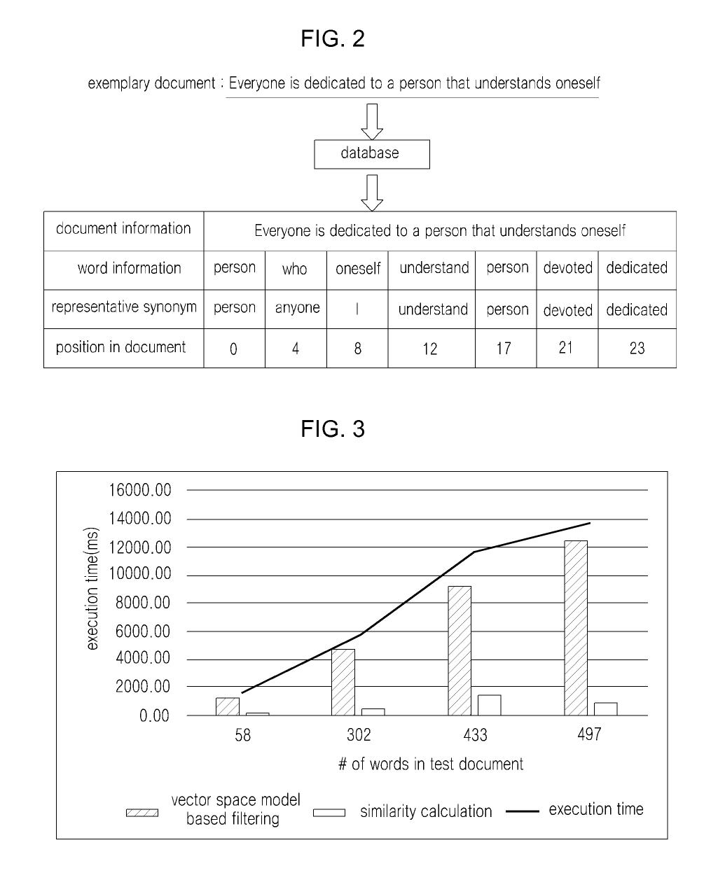

To solve demerits of conventional studies, the synonym dictionary-based plagiarism detecting system may perform three-step inspection including preprocessing for searching for a plagiarism portion in a document, filtering, and checking similarity between documents. First, in preprocessing, a text is divided by the sentence and by the word using an original document to be registered at a dictionary as a target, in order to search for a plagiarism portion of a document. The divided words experience a process of removing stop words and are then stored at database together with a representative synonym found through a synonym dictionary, a keyword position in a sentence, and the sentence itself. For example, referring to FIG. 2, if a document including a sentence “everyone will be devoted to a person that understands oneself” is input as an original document, it may be stored at database, as illustrated in a table of FIG. 2, through the above-described preprocessing process.

A to-be-tested target document that a user inputs to detect plagiarism goes through the same preprocessing process as the preprocessing process for processing an original document. The filtering step is performed with respect to information of the original document in the database using information of the to-be-tested target document thus formed. First, a vector is generated using information on a representative synonym of a keyword in a document and information on an appearance frequency in the document. After generating a vector with respect to an original document stored at the database in the same way, cosine similarity between two vectors is calculated through synchronizing of dimensions of the two vectors. A similar document of original documents stored at the database is filtered (or selected) using the calculated similarity. Finally, there is performed a plagiarism detecting step in which a plagiarism portion is detected by checking similarity between sentences of a to-be-tested target document, which a user uploads, and sentences of a selected candidate original document using an Euclidean distance algorithm. Thus, it is possible to detect plagiarism types such as copy, liberal translation, abbreviation, and structure change.

However, in the event that the plagiarism checking method is applied to a large-document environment, the performance analysis makes it possible to find the problem that a checking time is exponentially increased due to the large amount of computation needed to calculate a cosine similarity distance of a vector space model for filtering. Also, since the synonym dictionary based plagiarism detecting system is a system developed to operate independently, it is necessary to expand a database structure in order to provide users with record information of a plagiarism detecting service corresponding to each user on-line.

FIG. 3 is a diagram illustrating a result of evaluating performance of a synonym dictionary based plagiarism detecting system.

The performance on 82 original documents is evaluated based on a to-be-inspected target document having various sizes (the number of words included in the to-be-inspected target document). As the number of words included in the to-be-inspected target document increases, the number of events that comparison between an original document and the to-be-inspected target document is made increases, which is used as a valid performance evaluation reference.

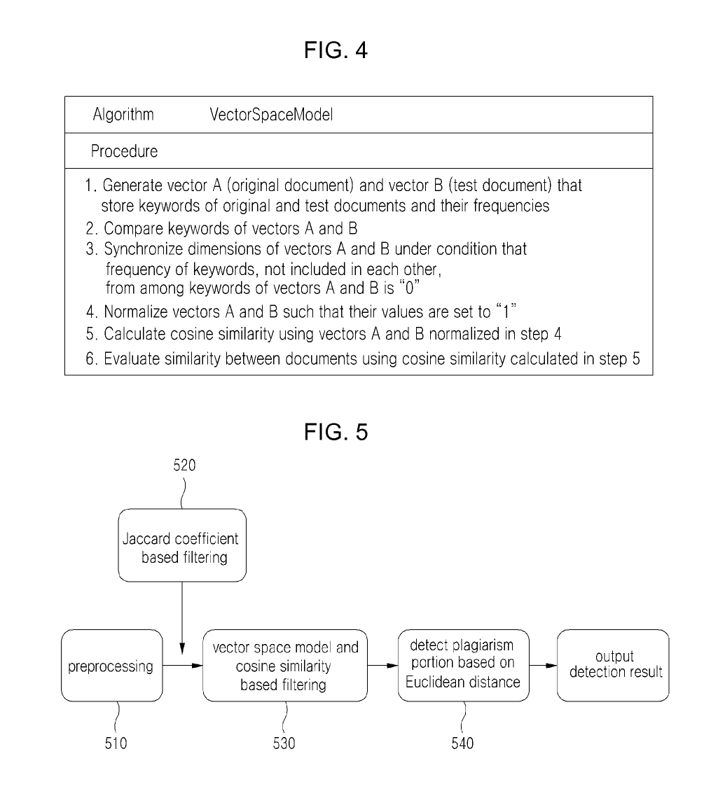

As the size of to-be-inspected target document increases, a decrease in speed is marked. The decrease in speed may mostly occur at the filtering step. This means that the synonym dictionary based plagiarism detecting system is unsuitable for the large-document environment. The decrease in speed may occur due to filtering that is based on a vector space model. The filtering using the vector space model is performed as illustrated in FIG. 4.

Referring to step 3 of FIG. 4, vectors compare keywords included therein every inspection, and dimensions of two vectors are synchronized. Since this operation has complexity of a maximum of O(n²), an execution time is exponentially increased as the number of keywords “n” is increased. Thus, in the inventive concept, there is used a novel filtering method where a Jaccard coefficient is applied between a conventional preprocessing step and a similarity based filtering step, thereby reducing the number of documents needed to calculate cosine similarity in the vector space model.

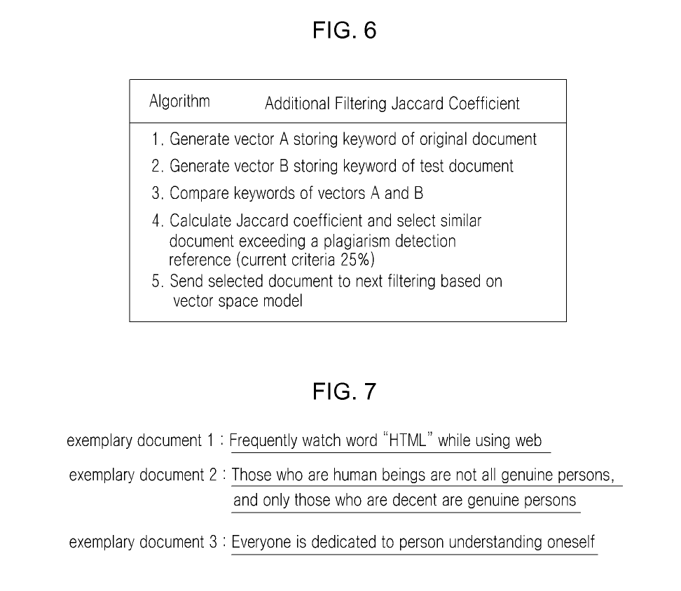

FIG. 5 is a flowchart schematically illustrating a plagiarism detecting method including a Jaccard coefficient based filtering step, according to an exemplary embodiment of the inventive concept. FIG. 6 is a diagram schematically illustrating a filtering step using a Jaccard coefficient, according to an exemplary embodiment of the inventive concept.

Referring to FIG. 5, first, in a preprocessing step 510, a text is divided by the sentence and by the word using an original document registered at a dictionary as a target, in order to search for a plagiarism portion of a document. A detailed preprocessing step 510 is substantially the same as described with reference to FIG. 2.

In the inventive concept, as illustrated in FIG. 5, if the preprocessing step 510 ends, then a first filtering step 520 using a Jaccard coefficient is performed as a novel filtering step. Referring to FIG. 6, in the first filtering step, a vector A and a vector B are generated by replacing and storing keywords of the original document and the to-be-inspected target document with a representative synonym of relevant words.

Afterwards, the number of same keywords is calculated by comparing the vectors thus generated. The Jaccard coefficient is calculated using the calculation result, and documents having the Jaccard coefficient exceeding a predetermined criterion (e.g., 25%) are provided to a second filtering step 530 using the vector space model and a cosine distance as a next filtering step. The second filtering step 530 and a plagiarism portion detecting step 540 are performed substantially the same as above described.

For example, it is assumed that plagiarism is checked using to-be-inspected documents including a sentence shown in FIG. 7 as a target in the event that an original document “everyone will be devoted to a person that understands oneself” shown in FIG. 2 exists in database.

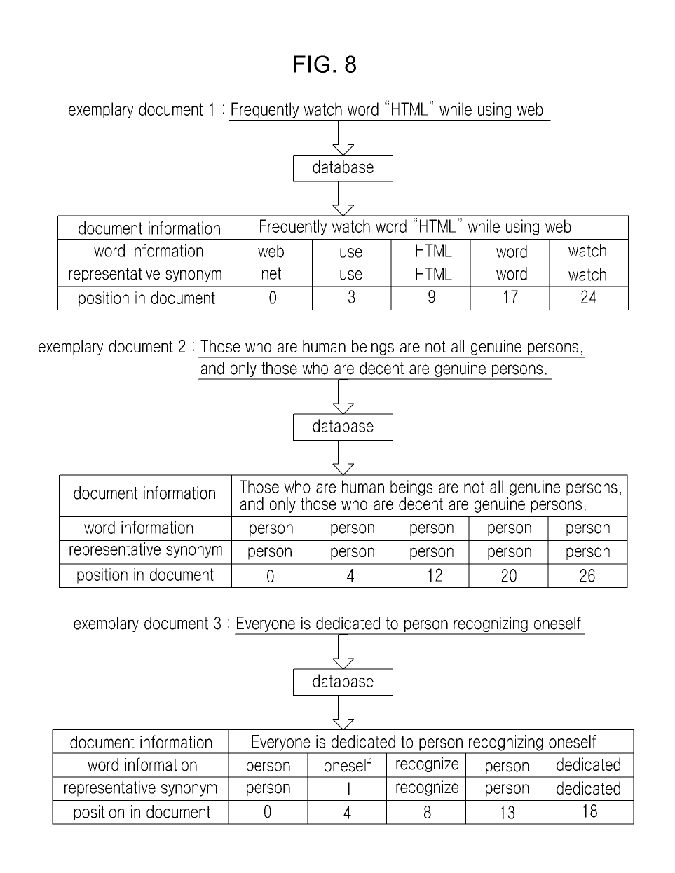

When the plagiarism check is performed with respect to three exemplary sentences input as to-be-inspected documents, a result shown in FIG. 8 is obtained through the preprocessing step. The following table 1 shows a result of calculating similarity for original document filtering with respect to the exemplary sentences using information stored at the database.

TABLE 1
Similarity

| Comp. with original document | Conventional filtering | Improved filtering |
|---|---|---|
| Target document 1 | 0.00 | 0.00 |
| Target document 2 | 0.63 | 0.17 |
| Target document 3 | 0.88 | 0.67 |

Here, a result of “Target document 2” is worthy of notice. A sentence of an original document shown in FIG. 2 is “Everyone will be devoted to a person that understands oneself”, and a sentence of the target document 2 shown in FIG. 7 is “Those who are human beings are not all genuine persons, and only those who are decent are genuine persons”. However, referring to a result of the table 1, in the event that a cosine similarity based filtering step 530 is only used in the filtering step, similarity is “0.63” and becomes a target of a Euclidean distance based plagiarism portion detecting step 540. In contrast, in the event that the cosine similarity based filtering step 530 is used together with a Jaccard coefficient based filtering step 520, similarity is “0.17” and does not become a target of the Euclidean distance based plagiarism portion detecting step 540. This means that the improved filtering provides more exact original document filtering.

Also, a difference exists in terms of performance. The Jaccard coefficient based filtering of FIG. 6 does not need synchronization of vector dimensions, thereby reducing the amount of computation as compared with the vector space model based filtering. In other words, it is possible to make a whole execution speed faster than that of a conventional system.

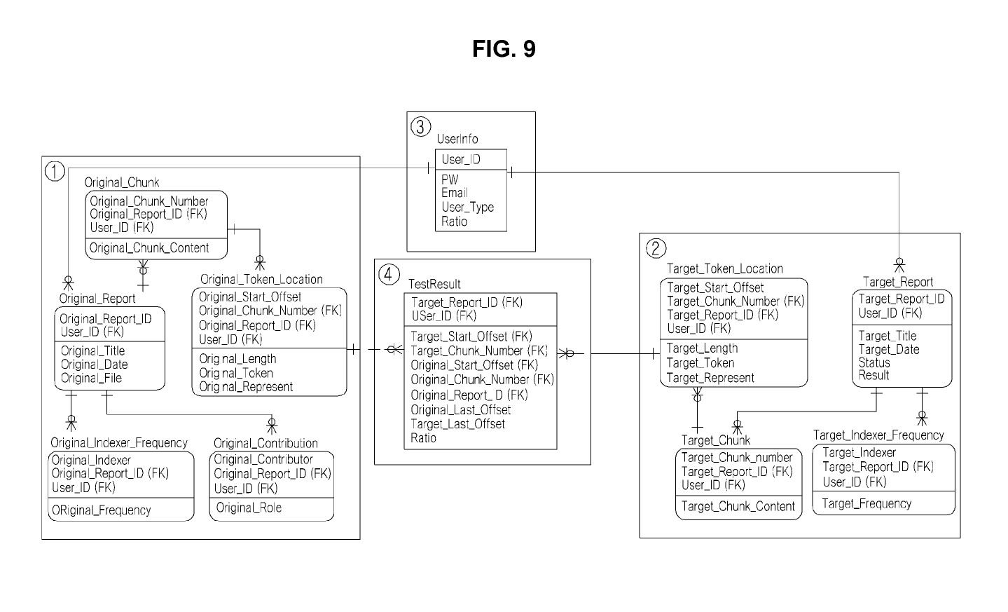

In addition, the database structure needs to be expanded to provide users with record information on plagiarism detection corresponding to each user on-line. Thus, a novel database schema shown in FIG. 9 may be designed based on a conventional database schema.

In FIG. 9, a block (\textcircled{1}) is a region for an original document to be uploaded by an institution user. Tables in the block (\textcircled{1}) store bibliographic information and original information of the original document, copyright holder information, frequency information of words appearing on the whole document, sentence information in the document, word positions in the document, and so on. Plagiarism check with the to-be-inspected target document is performed using the pieces of information thus stored.

In FIG. 9, a block (\textcircled{2}) is a region for the to-be-inspected target document to be uploaded by a general user. Tables in the block (\textcircled{2}) store the contents of the to-be-inspected target document, frequency information of words appearing in the whole document, sentence information in the document, word positions in the document, and so on. Plagiarism check with the original document is performed using the pieces of information thus stored.

In FIG. 9, a block (\textcircled{3}) is a region for storing user information of a service to which the inventive concept is applied. A table in block (\textcircled{3}) stores user ID and password, a user type (institution user or general user), and so on input upon subscribing. The pieces of information may be used to provide a service suitable for a relevant user.

In FIG. 9, a block (\textcircled{4}) is a region for storing plagiarism detection details of the to-be-inspected target document that a user tests. A table in the block (\textcircled{4}) enables a function of maintaining and managing a plagiarism detecting record of each user that will be provided through an on-line service.

Below, there will be described implementation of an on-line document plagiarism detecting system capable of managing a plagiarism detecting record of each user based on the document plagiarism detecting system according to an exemplary embodiment of the inventive concept and a database schema of FIG. 9.

FIG. 1 illustrates a schematic structure of an on-line plagiarism detection service system.

As illustrated in FIG. 1, an institution user 110 uploads an original document 111, corresponding to a plagiarism detection target, together with bibliographic information 112 on an on-line service to which a plagiarism detecting system 100 according to an exemplary embodiment of the inventive concept is applied. A general user 120 uploads only a to-be-inspected target document 121 to detect plagiarism. A plagiarism detecting result is stored at database 102 by the general user, thereby making it possible for the general user 120 to identify a record 122 of the plagiarism detecting result accumulated as needed.

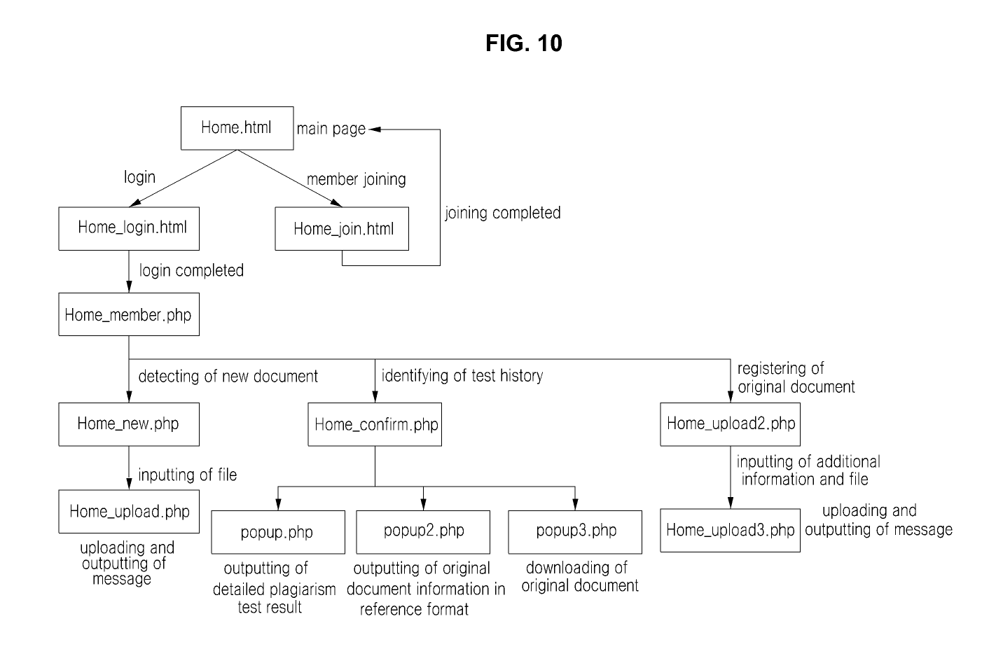

Also, on-line service configuration and flowchart shown in FIG. 10 may be used to support the following functions as well as a test record maintenance function.

1. A member is classified as an institution user or a general user. A function of detecting plagiarism and identifying a cumulative plagiarism detection record is provided to both the institution user and the general user, while a function of registering an original document is additionally provided to the institution user.

2. There is provided a detailed inquiry function of providing a plagiarism-suspected sentence detected from the to-be-inspected target document, a relevant sentence of a plagiarism original document, a plagiarism-suspected portion, a plagiarism level, etc. as a plagiarism detecting result.

3. As a function after plagiarism detecting, a citation information supporting function is provided which supports bibliographic information of documents found as the plagiarism original document in the form of reference.

4. There is provided an original document download function that allows selective downloading of original documents of documents found as the plagiarism original document.

The above-described functions may provide an on-line plagiarism detecting service friendlier to a service user.

In addition, in the inventive concept, an automatic reference citation mark attaching system is provided which attaches a citation mark on a reference. This may be applied to all fields associated with writing of technical documents, such as report, thesis, and engineering report of a teaching institution, as a field in which a solution of suspicion of plagiarism is previously supported with respect to a technical document to be published internally and externally.

The automatic reference citation mark attaching system according to an exemplary embodiment of the inventive concept searches for a similar document using the plagiarism document detecting technique and provides information on a reference based on the result. In particular, the automatic reference citation mark attaching system may provide information needed to automatically attach a reference citation mark to a plagiarism-suspected sentence or a function of directly attaching a reference citation mark thereto, in order to help to solve plagiarism doubt on a draft of a technical document that a user is writing.

A system and a service capable of automatically attaching a reference citation mark may independently operate on a single computer server. Alternatively, the system and service capable of automatically attaching a reference citation mark may be implemented such that an on-line service is provided through connection with a designated server through the Internet.

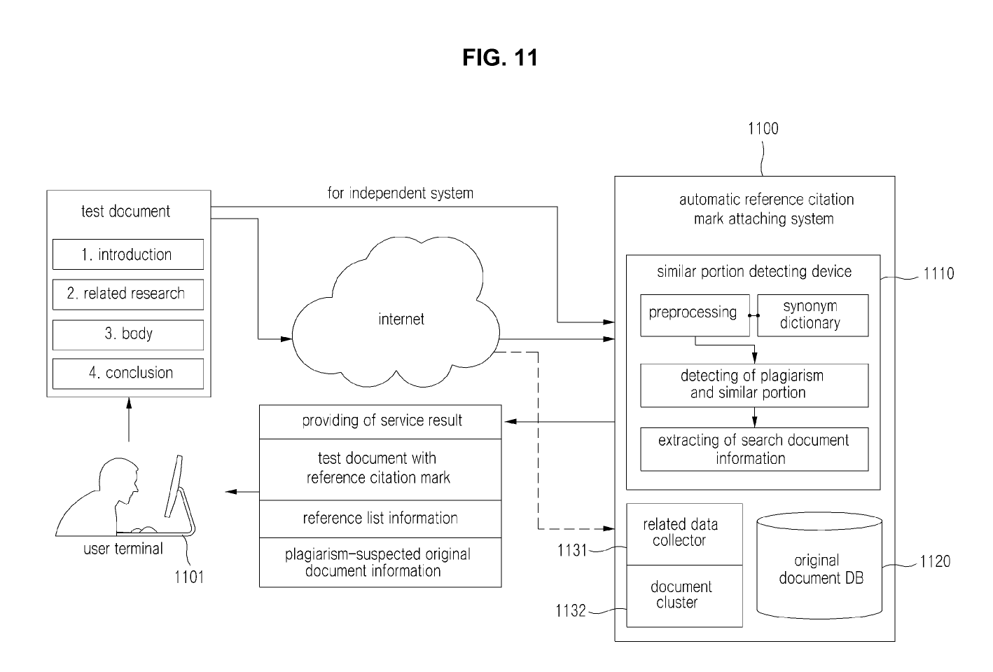

FIG. 11 is a structure diagram of an automatic reference citation mark attaching system according to an exemplary embodiment of the inventive concept.

As illustrated in FIG. 11, an automatic reference citation mark attaching system 1100 according to an exemplary embodiment of the inventive concept contains a similar portion detecting device 1110, original document database 1120, a related data collector 1131, and a document cluster 1132. The similar portion detecting device 1100 searches for an original document similar to a technical document from the original document database 1120 and detects plagiarism and similar portions using a synonym dictionary. The similar portion detecting device 1110 may correspond to a plagiarism detecting system described with reference to FIG. 1 and searches for a similar document on a to-be-inspected target document using a plagiarism detecting method including a Jaccard coefficient based filtering step. The related data collector 1131 is a web crawling device for automatically collecting a technical document from the Internet. Data collected by the related data collector 1131 is stored at the original document database 1120 through the document cluster 1132.

Referring to FIG. 11, a user (technical document writer) inputs a draft of a written technical document to the automatic reference citation mark attaching system 1100 as a to-be-inspected target document through a user terminal 1101 or through an Internet. At this time, the to-be-inspected target document means a general technical document written by a user and is a document including details, such as introduction, related research, body, and conclusion.

The automatic reference citation mark attaching system 1100 analyses and stores the to-be-inspected target document by the sentence through the similar portion detecting device 1110 or performs comparison with a sentence of an original document found from the Internet. The automatic reference citation mark attaching system 1100 permits bibliographic information of an original document including the found sentence to be included in a reference list, when a sentence having similarity over a predetermined criterion is found. The automatic reference citation mark attaching system 1100 provides a function of automatically attaching a citation mark on a relevant reference to a relevant sentence of the to-be-inspected target document or an Application Program Interface (API) supporting attachment.

To solve plagiarism doubt on a technical document, it is necessary to divide a to-be-inspected target document by the sentence and to search for a sentence of an original document, having high similarity indicating that plagiarism on a relevant sentence is suspected, from the original document DB 1120 stored at the automatic reference citation mark attaching system 1100.

At this time, a document stored at the original document DB 1120 may include not only a document directly registered in the automatic reference citation mark attaching system 1100 but also documents that are collected by the related data collector 1131 (an external document collector) from the Internet and are arranged using the document cluster 1132 according to document fields and types.

To search for a sentence of an original document suspected of plagiarism on a sentence of the to-be-inspected target document, it is necessary to find the following plagiarism types: a cloning type of plagiarism, plagiarism associated with synonym replacement, plagiarism associated with a change in a sentence structure, and plagiarism associated with abbreviation. Also, it is possible to support a user according to whether a relevant sentence of the to-be-inspected target document suspected of plagiarism is placed at any portion in the to-be-inspected target document.

For example, in the event that a sentence suspected of plagiarism is found at introduction and related research portions of the to-be-inspected target document, a reference citation mark is automatically attached by providing bibliographic information of an original document, having a sentence similar to the sentence suspected of plagiarism, in the form of reference and providing information for attaching a reference citation mark on the original document to a relevant sentence of the to-be-inspected target document or an Application Program Interface (API) for a document editor usable to attach a citation mark directly.

Also, if a plagiarism-suspected sentence similar to a sentence of an original document is detected from body and conclusion portions of the to-be-inspected target document, related information (bibliographic information of the original document and an original document suspected of plagiarism) may be supported to modify the detected portion. Since it is inappropriate to cite a sentence of another original document from the body and conclusion portions of a technical document with high similarity over a predetermined criterion, a relevant sentence of the to-be-inspected target document may be modified without attaching a citation mark.

The automatic reference citation mark attaching system 1100 provides a service result on a technical document to the user terminal 1101 through which the technical document is input. The automatic reference citation mark attaching system 1100 may provide an original sentence similar to a test sentence with respect to the technical document as a service result. For example, the automatic reference citation mark attaching system 1100 may provide the to-be-inspected target document to which a reference citation mark is attached, an API capable of supporting a function of attaching a reference citation mark, and information to be used as the reference citation mark. As another example, the automatic reference citation mark attaching system 1100 may provide information on an original document list configured in the form of reference list as a service result. As still another example, the automatic reference citation mark attaching system 1100 may provide brief information and bibliographic information of an original document including a sentence suspected of plagiarism as a service result.

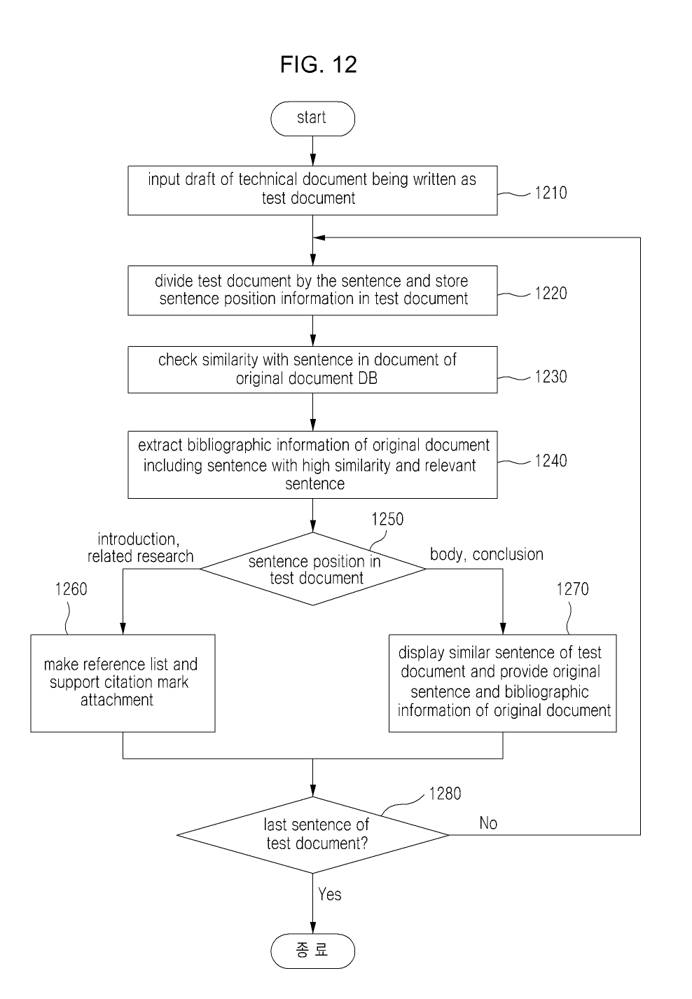

FIG. 12 is a flowchart schematically illustrating an automatic reference citation mark attaching method according to an exemplary embodiment of the inventive concept.

In step 1210, an automatic reference citation mark attaching system receives a draft of a technical document being written from a user as a to-be-inspected target document. At this time, the to-be-inspected target document may be a document including details such as an introduction, a related research, a body, and a conclusion.

In step 1220, the automatic reference citation mark attaching system divides the to-be-inspected target document received from the user by the sentence, simultaneously determines position information of the divided sentences in a document, and stores the determination result.

In step 1230, the automatic reference citation mark attaching system compares sentences divided in step 1220 with sentences belonging to a document in original document database and tests similarity between sentences.

In step 1240, the automatic reference citation mark attaching system determines bibliographic information of an original document, which includes a sentence similar to a plagiarism-suspected sentence of the to-be-inspected target document, using a result of testing similarity and extracts a relevant sentence and a position in a document.

In step 1250, the automatic reference citation mark attaching system determines whether a position of a sentence, determined to be a sentence suspected of plagiarism and included in the to-be-inspected target document, belongs to any one of details (introduction, related research, body, and conclusion).

In step 1260, as a consequence of determining that a position of a sentence, determined to be a sentence suspected of plagiarism and included in the to-be-inspected target document, corresponds to the introduction or the related research, the automatic reference citation mark attaching system provides information for supporting a reference list and citation mark attachment with respect to a plagiarism-suspected sentence of the to-be-inspected target document as a service result.

In step 1270, as a consequence of determining that a position of a sentence, determined to be a sentence suspected of plagiarism and included in the to-be-inspected target document, corresponds to the body or the conclusion, the automatic reference citation mark attaching system displays a plagiarism-suspected sentence in the to-be-inspected target document as a service result and provides an original sentence and bibliographic information of the original document including a sentence similar to the plagiarism-suspected sentence of the to-be-inspected target document.

In step 1280, for reference citation mark attachment, the automatic reference citation mark attaching system determines whether a sentence divided in step 1220 is a last sentence in the to-be-inspected target document. If the sentence is the last sentence in the to-be-inspected target document, the method ends. If the sentence is not the last sentence in the to-be-inspected target document, that is, when a next sentence exists, the above-described steps 1220 to 1270 are repeated.

Accordingly, it is possible to provide various services for preemptively solving plagiarism suspicion on a draft of a technical document being written.

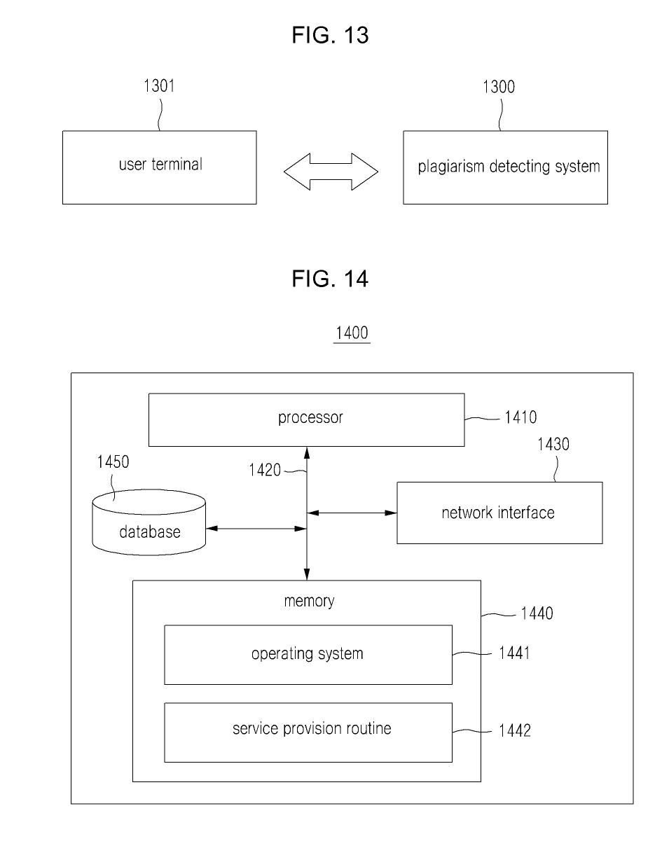

FIG. 13 is a diagram schematically illustrating a system (hereinafter referred to as “plagiarism detecting system”) for an on-line plagiarism detecting service and automatic reference citation mark attachment and a user terminal. In FIG. 13, a plagiarism detecting system 1300 and a user terminal 1301 are illustrated. In FIG. 13, an arrow means that data is exchanged between the plagiarism detecting system 1300 and the user terminal 1301 through a wireless/wire network.

The user terminal 1301 may mean all terminal devices capable of connecting with a web/mobile site associated with the plagiarism detecting system 1300 or capable of installing and executing a service-dedicated application. For example, the terminal devices may include, but not limited to, a personal computer, a notebook computer, a tablet, and a wearable computer that an institution user or a general user uses. At this time, the user terminal 1301 performs the following operations under a control of a web/mobile site or a dedicated application: configuration of a service screen, data input, data transmission and reception, and data storage.

The plagiarism detecting system 1300 plays a role of a service platform for detecting plagiarism by comparing similarities of documents. In particular, as described above, the plagiarism detecting system 1300 uses a plagiarism detecting method to which a Jaccard coefficient based filtering step is added and provides a plagiarism detecting service to users on-line. Also, the plagiarism detecting system 1300 automatically attaches a citation mark on a reference to a technical document or proposes modification with respect to a sentence suspected of plagiarism, thereby making it possible to provide a service for preemptively solving plagiarism doubt through a similar sentence finding operation with respect to a draft of a technical document being written.

FIG. 14 is a block diagram for describing an internal configuration of a plagiarism detecting system, according to an exemplary embodiment of the inventive concept.

A plagiarism detecting system 1400 according to an exemplary embodiment of the inventive concept contains a processor 1410, a bus 1420, a network interface 1430, a memory 1440, and database 1450. The memory 1440 includes an operating system 1441 and a service provision routine 1442. In other exemplary embodiments, the plagiarism detecting system 1400 may further include components that are not illustrated in FIG. 14. However, it is unnecessary to illustrate conventional components exactly. For example, the plagiarism detecting system 1400 may include other components, such as a display and a transceiver.

The memory 1440 is a computer-readable storage medium and includes a permanent mass storage device, such as Random Access Memory (RAM), Read Only Memory (ROM), and a disk drive. The memory 1440 further stores program codes for the operating system 1441 and the service providing routine 1442. These software components may be loaded from a computer-readable storage medium, which is separate from the memory 1440, using drive mechanism (not shown). The discrete computer-readable storage medium may contain the following: floppy drive, disk, tape, DVD/CD-ROM drive, and memory card. In other exemplary embodiments, software components may be loaded through the network interface 1430 from the memory 1440, not the computer-readable storage medium.

The bus 1420 enables communications and data transfer between components of the plagiarism detecting system 1400. The bus 1420 may be implemented using a high-speed serial bus, a parallel bus, a Storage Area Network (SAN), and/or any other communication technique.

The network interface 1430 may be a computer hardware component for connecting the plagiarism detecting system 1400 to a computer network. The network interface 1430 may connect the plagiarism detecting system 1400 to the computer network through wireless or wire connection.

The database 1450 is used to store and maintain information associated with services for detecting plagiarism on-line and providing the detected result. In FIG. 14, an embodiment of the inventive concept is exemplified as the database 1450 is built in the plagiarism detecting system 1400. However, the scope and spirit of the inventive concept may not be limited thereto. The database 1450 may be skipped according to a system implementation way or environment, or the whole or a part of the database 1450 may be implemented with external database that is built on a discrete other system.

The processor 1410 is configured to process instructions of a computer program by performing basic arithmetic, logic, and an input/output operation of the plagiarism detecting system 1400. The instructions may be provided from the memory 1440 or the network interface 1430 to the processor 1410 through the bus 1420. The processor 1410 may be configured to execute a program code for plagiarism detection, automatic reference citation mark attachment, and on-line service described with reference to FIGS. 1 to 12.

An operation of the processor 1410 may be executed substantially the same as described with reference to FIGS. 1 to 12, and a detailed description thereof is thus omitted.

The above-described plagiarism detecting method and automatic reference citation mark attaching method may include a part of operations described with reference to FIGS. 1 to 12 or may include additional operations as well as the operations described with reference to FIGS. 1 to 12. Also, two or more operations may be combined, and a sequence of operations may be changed.

Methods according to exemplary embodiments of the inventive concept may be implemented in the form of program instruction that is executable through various computer systems and may be stored at a computer-readable medium. Also, a program according to the inventive concept may be implemented with a PC-based program or an application dedicated to a mobile terminal.

According to exemplary embodiments of the inventive concept, keywords of an original document and a to-be-inspected target document may be stored at database together with a representative synonym found from the synonym dictionary and may be used at a plagiarism identifying step. Thus, it is possible to find the following various plagiarism types: copying a sentence of an original document without modification, liberal translation where a keyword is replaced with any other similar keyword, and structure change where the word order of a sentence is changed. A plagiarism detecting system using morpheme analysis may be disadvantageous in that a time taken to detect plagiarism becomes longer as compared with a plagiarism detecting system using pattern matching. According to an exemplary embodiment of the inventive concept, to solve such a disadvantage, a Jaccard coefficient based filtering step is added before a cosine distance based filtering step, thereby reducing the number of documents needed to calculate similarity for identifying whether or not of plagiarism. That is, performance may be improved in terms of an execution time as compared with a conventional system using only the cosine distance based filtering step. Also, according to an exemplary embodiment of the inventive concept, since a plagiarism detection service is provided to a plurality of users on-line, it is possible to support the following various functions usable through an on-line service: a general plagiarism document detecting function, a history function for identifying a plagiarism detection history, a details query function for identifying a plagiarism portion in a document, and a citation information supplying function for providing bibliographic information of a found document. Moreover, according to an exemplary embodiment of the inventive concept, since a citation mark on a reference is automatically attached to a technical document, it is possible to prevent a social plagiarism issue in advance by solving suspicion of plagiarism of the technical document. Since there are provided various services for preemptively solving plagiarism suspicion on a draft of a technical document being written through similar sentence detecting, it is possible to provide a technical document writing environment that is free from suspicion of plagiarism.

The units described herein may be implemented using hardware components, software components, or a combination thereof. For example, devices and components described therein may be implemented using one or more general-purpose or special purpose computers, such as, but not limited to, a processor, a controller, an arithmetic logic unit, a digital signal processor, a microcomputer, a field programmable gate array (FPGA), a programmable logic unit, a microprocessor or any other device capable of responding to and executing instructions in a defined manner. A processing device may run an operating system (OS) and one or more software applications that run on the OS. The processing device also may access, store, manipulate, process, and create data in response to execution of the software. For the sake of easy understanding, an embodiment of the inventive concept is exemplified as one processing device is used; however, one skilled in the art will appreciate that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The example embodiments may be recorded in non-transitory computer-readable media including program instructions to perform various operations embodied by a computer. The media may also include, alone or in combination with the program instructions, data files, data structures, and the like. The media and program instructions may be those specially designed and constructed for the purposes, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as floptical disks; and hardware devices that are specially to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be to act as one or more software modules in order to perform the operations of the above-described embodiments.

While the inventive concept has been described with reference to exemplary embodiments, it will be apparent to those skilled in the art that various changes and modifications may be made without departing from the spirit and scope of the inventive concept. Therefore, it should be understood that the above embodiments are not limiting, but illustrative.

What is claimed is:

1. An automatic reference citation mark attaching system comprising:
a memory on which at least one program is loaded; and
at least one processor,
wherein based on a control of the program, the at least one processor performs operations of:
checking similarities between original sentences, included in an original document, and test sentences generated by dividing a to-be-inspected target document by the sentence; and
providing bibliographic information of the original document as reference information on the test sentences when the similarities between the test sentences and the original sentences exceed a predetermined criterion.

2. The automatic reference citation mark attaching system of claim 1, wherein the providing of bibliographic information comprises:
writing bibliographic information of the original document into a reference list on the test sentence; and
attaching a citation mark on a relevant reference to the test sentence.

3. The automatic reference citation mark attaching system of claim 1, wherein the providing of bibliographic information comprises:
providing an application program interface (API) for attaching a citation mark on a reference to the test sentence together with bibliographic information of the original document.

4. The automatic reference citation mark attaching system of claim 1, wherein the providing of bibliographic information comprises:
determining positions of the test sentences based on a list for dividing the to-be-inspected target document;
when a test sentence is placed at an introduction or related research of the list, writing the bibliographic information of the original document into a reference list on the test sentence and attaching a citation mark on a relevant reference to the test sentence; and
when the test sentence is placed at a body or conclusion of the list, displaying the original sentence and the bibliographic information together with the test sentence as relevant information for supporting modification of the test sentence.

5. The automatic reference citation mark attaching system of claim 1, wherein the checking of similarity comprises:
performing a preprocessing operation where each of the original sentences and the test sentences is divided by the word and the division result is stored at database together with a representative synonym found from a synonym dictionary;
selecting first sentences, similar to a test sentence, from among the original sentences, according to a Jaccard coefficient based similarity; and
selecting a second sentence, similar to the test sentence, from among the first sentences according to a cosine distance based similarity.

6. The automatic reference citation mark attaching system of claim 5, wherein the selecting of first sentences comprises:
generating a first vector, in which a word included in the original sentences is replaced with a representative synonym of a relevant word, and a second vector in which a word included in the to-be-inspected test sentences is replaced with a representative synonym of a relevant word;
comparing the first vector and the second vector to calculate a Jaccard coefficient from the number of same words; and
selecting candidate sentences of which the Jaccard coefficient is over a plagiarism detection criterion, as the first sentences.

7. The automatic reference citation mark attaching system of claim 5, wherein the selecting of a second sentence comprises:
generating a first vector, which stores a representative synonym of a word included in the first sentence and an appearance frequency of a relevant word, and a second vector which stores a representative synonym of a word included in the test sentence and an appearance frequency of a relevant word;
synchronizing dimensions of the first and second vectors to calculate a cosine similarity; and
selecting a first sentence of which the cosine similarity is over a plagiarism detection criterion, as the second sentence.

8. A plagiarism detecting system comprising:
a memory on which at least one program is loaded; and
at least one processor,
wherein based on a control of the program, the at least one processor performs operations of:
performing a preprocessing operation where each of original documents and a to-be-inspected target document is divided by the word and the division result is stored at database together with a representative synonym found from a synonym dictionary;
selecting a first document, similar to the to-be-inspected target document, from among the original documents, according to a Jaccard coefficient based similarity; and
selecting a second document, similar to the to-be-inspected target document, from among the first documents according to a cosine distance based similarity.

9. The plagiarism detecting system of claim 8, wherein the preprocessing operation comprises:
searching for the representative synonym from the synonym dictionary with respect to word-unit keywords divided from the original documents and the to-be-inspected target document and storing the keywords, information on keyword positions in sentences, and the representative synonym at the database, and
wherein the database is used to find plagiarism types including a copy type, an abbreviation type, a liberal translation type, and a sentence structure change type.

10. The plagiarism detecting system of claim 8, wherein the selecting of a first document comprises:
generating a first vector, in which a word included in the original document is replaced with a representative synonym of a relevant word, and a second vector in which a word included in the to-be-inspected target document is replaced with a representative synonym of a relevant word;
comparing the first vector and the second vector to calculate a Jaccard coefficient from the number of same words; and
selecting a candidate document of which the Jaccard coefficient is over a plagiarism detection criterion, as the first document.

11. The plagiarism detecting system of claim 8, wherein the selecting of a second document comprises:
generating a first vector, which stores a representative synonym of a word included in the first document and an appearance frequency of a relevant word, and a second vector which stores a representative synonym of a word included in the to-be-inspected target document and an appearance frequency of a relevant word;
synchronizing dimensions of the first and second vectors and calculating cosine similarity; and
selecting a first document of which the cosine similarity is over a plagiarism detection criteria, as the second document

12. The plagiarism detecting system of claim 11, wherein the calculating of a cosine similarity comprises:
comparing the first vector and the second vector and synchronizing dimensions of the first and second vectors under a condition where a frequency of words not included in each other is “0”;
normalizing the first vector and the second vector respectively such that each of the first vector and the second vector has a value of “1”; and
calculating the cosine similarity using the normalized first and second vectors.

13. A plagiarism detecting system comprising:
a memory on which at least one program is loaded; and
at least one processor,
wherein based on a control of the program, the at least one processor performs operations of:
dividing original documents by the word to store the division result at database together with a representative synonym found from a synonym dictionary;
dividing a to-be-inspected target document, uploaded from a user through an internet, by the word to store the division result at the database together with a representative synonym found from the synonym dictionary;
checking a plagiarism of the to-be-inspected target document by comparing the to-be-inspected target document and the original documents; and
providing the checking result to one of the user and a manager registering the original documents.

14. The plagiarism detecting system of claim 13, wherein the providing of the checking result comprises providing at least one of information on the to-be-inspected target document, a plagiarism-suspected portion detected from the to-be-inspected target document, a plagiarism-suspected sentence including the plagiarism-suspected portion, an original sentence compared with the plagiarism-suspected sentence, or information on an original document including the original sentence, as the checking result.

15. The plagiarism detecting system of claim 13, wherein the providing of the checking result comprises providing a download function on an original document corresponding to to-be-inspected target document determined as being plagiarized.

16. The plagiarism detecting system of claim 13, wherein the checking of a plagiarism comprises:
replacing word-unit keywords divided from the original document and the to-be-inspected target document with a representative synonym found from the synonym dictionary;
selecting first documents, similar to the to-be-inspected target document, from among original documents according to a Jaccard coefficient similarity; and
selecting a second document, similar to the to-be-inspected target document, from among the first documents according to a cosine distance based similarity.
